(19) United States
(12) Patent Application Publication
(10) Pub. No.: US 2025/0030037 A1
(43) Pub. Date: Jan. 23, 2025

(54) ACTIVE PRESSURE CONTROL WEDGE MECHANISM FOR IMPROVED LIQUID METAL BATTERY PERFORMANCE

(71) Applicant: GM Global Technology Operations LLC, Detroit, MI (US)

(72) Inventors: Alexander Millerman, Bloomfield Township, MI (US); Chunhao J. Lee, Troy, MI (US); Yongjie Zhu, Troy, MI (US); Insu Chang, Troy, MI (US); Jun-mo Kang, Ann Arbor, MI (US); Chen-fang Chang, Bloomfield Hills, MI (US)

(21) Appl. No.: 18/355,115

(22) Filed: Jul. 19, 2023

(51) Int. Cl. H01M 10/04; H01M 10/48; H01M 50/249

(52) U.S. Cl. CPC H01M 10/0468; H01M 10/48; H01M 50/249; B60L 50/64; B60L 58/10; H01M 2220/20

(57) ABSTRACT

A vehicle includes an apparatus for performing a method of controlling a pressure within a battery. The battery is disclosed between a support plate at a first side of the battery and a pressure plate disposed at a second side of the battery opposite the first side. The pressure plate is movable with respect to the support plate to control the pressure of the battery and including a first plate wedge. The first actuator wedge is moved parallel to the pressure plate with the first actuator wedge in contact with the first plate wedge to control a force applied by the first actuator wedge to the first plate wedge to move the pressure plate with respect to the support plate. Moving the pressure plate controls the pressure within the battery.

### INTRODUCTION

The subject disclosure relates to increasing a performance of a battery and, in particular, to controlling pressure applied to a battery that operates under high pressure conditions to increase its performance.

A Lithium Metal Battery (LMB) can be used to provide power in an electric vehicle. When the LMB is operated under low pressure conditions, dendrites can grow between the anode and cathode of the battery. These dendrites limit the life span and effectiveness of the LMB. However, dendrite growth can be reduced by operating the LMB under high pressure conditions. Accordingly, it is desirable to provide a method and apparatus for applying high pressure to the battery during its operation.

### SUMMARY

In one exemplary embodiment, an apparatus for controlling a pressure within a battery is disclosed. The apparatus includes a support plate at a first side of the battery, a pressure plate disposed at a second side of the battery opposite the first side, the pressure plate movable with respect to the support plate to control the pressure of the battery, a first plate wedge coupled to the pressure plate, and a first actuator wedge in contact with the first plate wedge, the first actuator wedge configured to move parallel to the pressure plate to control a force applied by the first actuator wedge to the first plate wedge to move the pressure plate with respect to the support plate, wherein moving the pressure plate controls the pressure within the battery.

In addition to one or more of the features described herein, the apparatus further includes a second plate wedge coupled to the pressure plate and a second actuator wedge for controlling a force applied to the second plate wedge, wherein the second actuator wedge moves anti-parallel to the first actuator wedge. The apparatus further includes a screw that passes through the first actuator wedge and the second actuator wedge, wherein the screw has a first thread direction at the first actuator wedge and a second thread direction at the second actuator wedge. The screw is maintained at a fixed location with respect to the support plate. The apparatus further includes a motor for rotating the screw. The apparatus of claim 1. further includes a pressure sensor configured to detect the pressure within the battery and a controller configured to control the motor based on the pressure to control the pressure within the battery. The first plate wedge includes a first inclined surface and the first actuator wedge has an first actuator inclined surface in contact with the first inclined surface of the first plate wedge and is oriented in an opposite direction as the first inclined surface.

In another exemplary embodiment, a method for controlling a pressure within a battery is disclosed. The battery is disclosed between a support plate at a first side of the battery and a pressure plate disposed at a second side of the battery opposite the first side. The pressure plate is movable with respect to the support plate to control the pressure of the battery and including a first plate wedge. The first actuator wedge is moved parallel to the pressure plate with the first actuator wedge in contact with the first plate wedge to control a force applied by the first actuator wedge to the first plate wedge to move the pressure plate with respect to the support plate. Moving the pressure plate controls the pressure within the battery.

In addition to one or more of the features described herein, the pressure plate includes a second plate wedge, and the method further includes moving a second actuator wedge for controlling a force applied by the second actuator wedge to the second plate wedge, wherein the second actuator wedge moves anti-parallel to the first actuator wedge. A screw passes through the first actuator wedge and the second actuator wedge, wherein the screw has a first thread direction at the first actuator wedge and a second thread direction at the second actuator wedge. The method further includes maintaining the screw at a fixed location with respect to the support plate. The method further includes rotating the screw via a motor. The method further includes detecting the pressure within the battery and controlling the motor based on the pressure to control the pressure within the battery. The first plate wedge includes a first inclined surface and the first actuator wedge has an first actuator inclined surface in contact with the first inclined surface of the first plate wedge and is oriented in an opposite direction as the first inclined surface.

In yet another exemplary embodiment, a vehicle is disclosed. The vehicle includes a battery, a support plate at a first side of the battery, a pressure plate disposed at a second side of the battery opposite the first side, the pressure plate movable with respect to the support plate to control a pressure of the battery, a first plate wedge coupled to the pressure plate, and a first actuator wedge in contact with the first plate wedge, the first actuator wedge configured to move parallel to the pressure plate to control a force applied by the first actuator wedge to the first plate wedge to move the pressure plate with respect to the support plate, wherein moving the pressure plate controls the pressure within the battery.

In addition to one or more of the features described herein, the vehicle further includes a second plate wedge coupled to the pressure plate and a second actuator wedge for controlling a force applied to the second plate wedge, wherein the second actuator wedge moves anti-parallel to the first actuator wedge. The vehicle further includes a screw that passes through the first actuator wedge and the second actuator wedge, wherein the screw has a first thread direction at the first actuator wedge and a second thread direction at the second actuator wedge. The screw is maintained at a fixed location with respect to the support plate. The vehicle further includes a motor for rotating the screw. The vehicle f further includes a pressure sensor configured to detect the pressure within the battery and a controller configured to control a motor based on the pressure to control the pressure within the battery.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an electric vehicle in accordance with an exemplary embodiment;

FIG. 2 shows a battery system for a battery in an exemplary embodiment;

FIG. 3 shows a top view and a side view of the pressure plate in an illustrative embodiment;

FIG. 4 shows a side view and top view of the actuator device in an illustrative embodiment;

FIG. 5 shows a top view of a pressure plate in another embodiment;

FIG. 6 shows a top view of an embodiment including a first single-wedge activation device and a second single-wedge activation device; and

FIG. 7 shows the actuator device in another embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

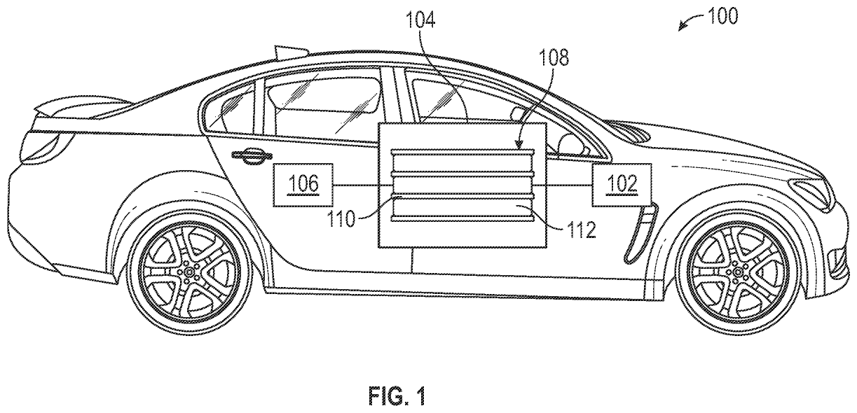

In accordance with an exemplary embodiment, FIG. 1 shows an electric vehicle 100. The electric vehicle 100 includes an electric motor 102 a battery system 104 and a controller 106. The battery system 104 includes a battery 108, such as a lithium metal battery (LMB), that includes anodes 110 and cathodes 112 that are susceptible to forming dendrites during operation at standard pressures or ambient pressures. The dendrites diminish the quality of operation of the battery 108. The battery system 104 includes a device that applies a pressure to the battery 108 and is able to adjust or control the pressure as desired.

The controller 106 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 106 may include a non-transitory computer-readable medium that stores instructions which, when processed by one or more processors of the controller 106, implement a method of operating the battery system 104 so as to apply a pressure at the battery 108, as desired.

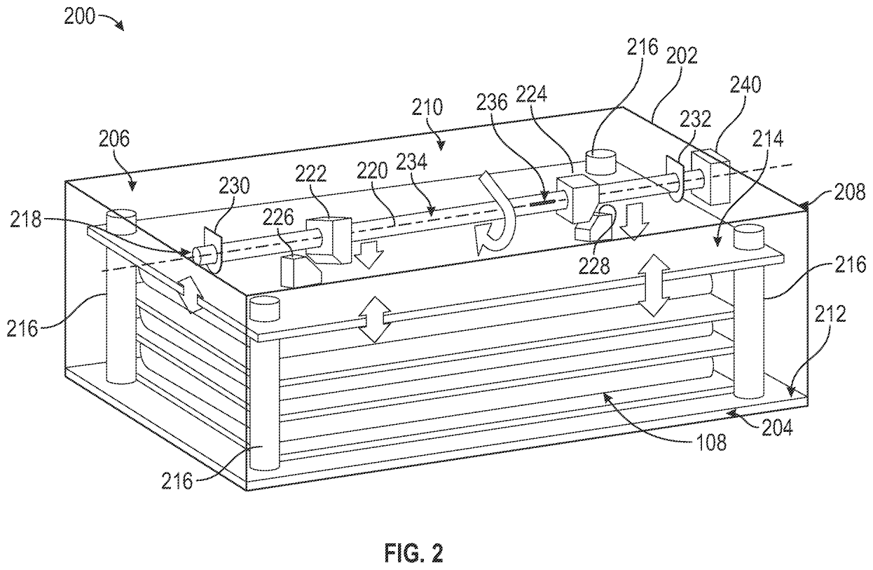

FIG. 2 shows a battery system 200 for a battery 108 in an exemplary embodiment. The battery system 200 includes a housing 202 that houses the battery 108. The housing 202 can have a bottom surface 204, a top surface 206 and side walls 208. A pressure control device 210 for the battery 108 is disposed inside the housing 202. The pressure control device 210 includes a support plate 212 upon which the battery 108 is disposed, a pressure plate 214 that is movable with respect to the support plate, and posts 216 that guide a movement of the pressure plate in a direction either towards or away from the support plate. The support plate 212 can be the same as the bottom surface of the housing 202. The support plate 212 is placed against a first side of the battery 108, and the pressure plate 214 is placed against a second side of the battery 108 that is opposite the first side. The pressure plate 214 can be moved toward the support plate 212 to increase a pressure applied on the battery 108. The pressure plate 214 can be moved away from the support plate 212 to decrease the pressure applied on the battery 108.

An actuator device 218 is disposed at a location above the pressure plate 214. The actuator device 218 includes a screw 220 having a first actuator wedge 222 and a second actuator wedge 224. The screw 220 is maintained at a fixed location with respect to the support plate 212 via one or more bearing supports. A first bearing support 230 and a second bearing support 232 are shown for ease of illustration. The screw 220 includes a first half 234 having a first thread direction (e.g., right-handed thread) and a second half 236 having a second thread direction (e.g., left-handed thread).

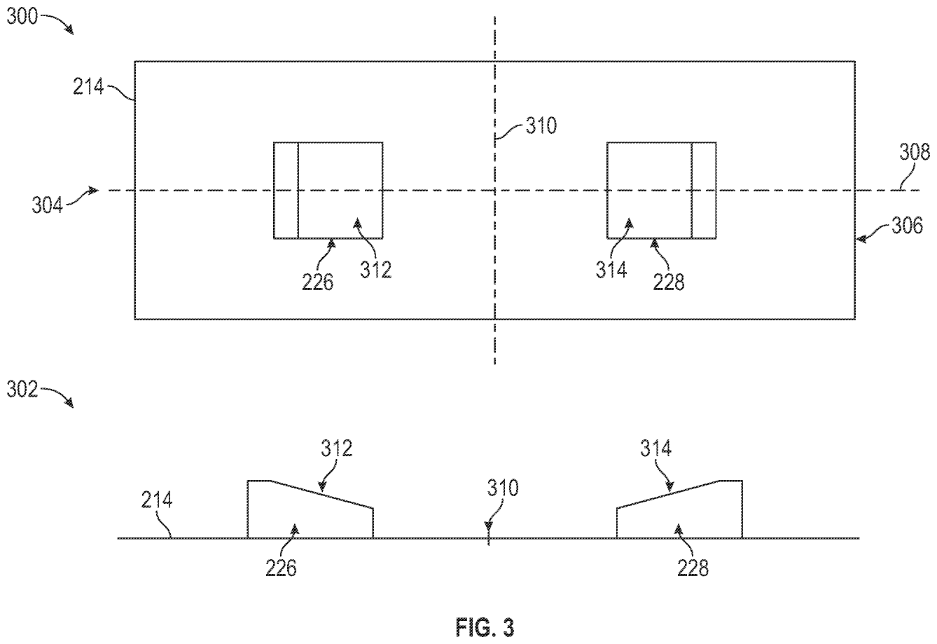

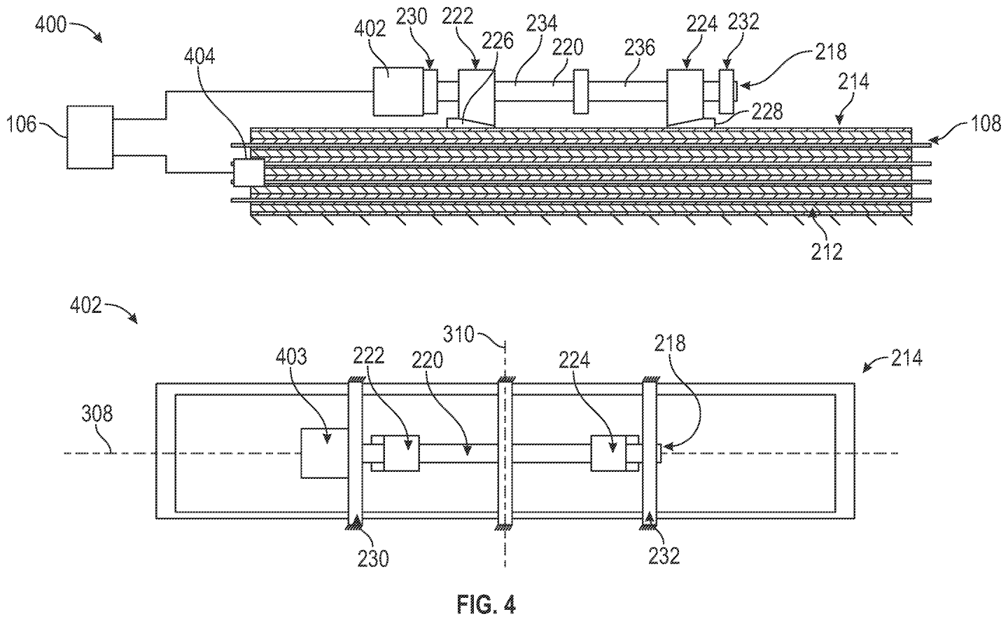

The pressure plate 214 has a planar outer surface that includes plate wedges thereon for producing the motion of the pressure plate. A first plate wedge 226 is located at first location along the pressure plate 214 and a second plate wedge 228 is located at a second location along the pressure plate 214. A force is applied to the pressure plate via a contact between the first plate wedge 226 and the first actuator wedge 222 as well as a contact between the second plate wedge 228 and the second actuator wedge 224, as discussed herein with respect to FIGS. 3 and 4.

FIG. 3 shows a top view 300 and a side view 302 of the pressure plate 214 in an illustrative embodiment. For ease of illustration the pressure plate 214 extends from a first end 304 to a second end 306. A central wedge line 308 extends along the pressure plate 214 from the first end 304 to the second end 306. The first plate wedge 226 is disposed at a first location on the outer surface of the pressure plate 214 and the second plate wedge 228 is disposed at a second location on the outer surface of the pressure plate. The first location and the second location are along the central wedge line 308. A midpoint 310 is located halfway between the first plate wedge 226 and the second plate wedge 228. The first plate wedge 226 includes a first inclined surface 312 inclined toward the midpoint 310. The second plate wedge 228 includes a second inclined surface 314 facing toward the midpoint 310. Thus, the first inclined surface 312 and the second inclined surface 314 are inclined toward each other.

FIG. 4 shows a side view 400 and top view 402 of the actuator device 218 in an illustrative embodiment. The screw 220 is aligned parallel to the central wedge line 308 and can be disposed such that an intersection between the first half 234 and the second half 236 is located above the midpoint 310. The first half 234 of the screw 220 passes through a first hole (not shown) in the first actuator wedge 222 and the second half 236 of the screw passes through a second hole (not shown) in the second actuator wedge 224. The first hole has a thread that corresponds to the thread of the first half 234 (i.e., right-handed thread). The second hole has a thread that correspond to the thread of the second half 236 (i.e., left-handed thread). Thus, the first actuator wedge 222 and the second actuator wedge 224 are configured to move anti-parallel to each other. Rotating the screw in one direction causes the first actuator wedge 222 and the second actuator wedge 224 to move in towards each other. Rotating the screw 220 in an opposite direction causes the first actuator wedge 222 and the second actuator wedge 224 to move away from each other. A motor 403 controls the speed and direction of the rotation of the screw.

The first actuator wedge 222 includes a first actuator inclined surface that is oriented in the opposite direction as the first inclined surface 312 of the first plate wedge 226 and is in contact with the first inclined surface. Similarly, the second actuator wedge 224 includes a second actuator inclined surface that is oriented in the opposite direction as the second inclined surface 314 of the second plate wedge 228 and is in contact with the second inclined surface. Thus, the first actuator inclined surface and the second actuator inclined surface are oriented away from each other.

When the screw 220 is rotated in one direction, the first actuator wedge 222 moves against the first plate wedge 226 (via their inclined surfaces) to increase a force that is directed against the pressure plate 214, causing the pressure plate to move toward the support plate 212, thereby increasing the pressure within the battery 108. Similar results occur between the second actuator wedge 224 and the second plate wedge 228.

When the screw is rotated in the opposite direction, the first actuator wedge 222 moves away from the first plate wedge 226 to reduce a force that is directed against the pressure plate 214, thereby allowing the pressure plate to move away from the support plate 212 and decreasing the pressure within the battery 108. Similar results occur between the second actuator wedge 224 and the second plate wedge 228.

A pressure sensor 404 can be disposed within the battery 108 to record pressure measurements. The pressure measurement can be sent to a controller (e.g., controller 106) that can determine a need to increase or decrease a pressure in the battery 108 and to send a signal to the motor to adjust the pressure accordingly.

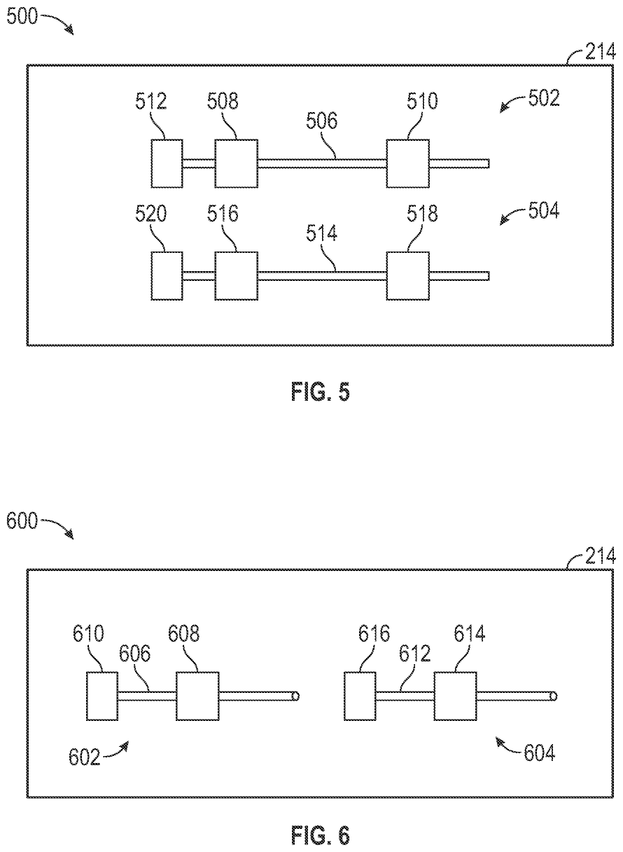

FIG. 5 shows a top view 500 of a pressure plate 214 in another embodiment. The actuator device includes a first actuator device 502 placed at a first location of the pressure plate 214 and a second actuator device 504 plated at a second location of the pressure plate. The first actuator device 502 includes a first screw 506 and actuator wedges 508 and 510 corresponding to plate wedges of the pressure plate 214. A first motor 512 controls a rotation of the first screw 506. Similarly, the second actuator device 504 includes a second screw 514 and actuator wedges 516 and 518 corresponding to plate wedges of the pressure plate 214. A second motor 520 controls a rotation of the second screw 514. The first actuator device 502 and the second actuator device 504 can therefore be activated independently to provide different pressures along the surface of the pressure plate 214 and thus at different locations within the battery 108.

In various embodiments, the actuator device can have a single actuator wedge acting against a single plate wedge. FIG. 6 shows a top view 600 of an embodiment including a first single-wedge activation device 602 and a second single-wedge activation device 604. The first single-wedge activation device 602 includes a first screw 606, a first actuator wedge 608 corresponding to a plate wedge of the pressure plate 214, and first motor 610 for controlling the rotation of the first screw 606 and thus the pressure applied by the first actuator wedge 608. The second single-wedge activation device 604 includes a second screw 612, a second actuator wedge 614 corresponding to a plate wedge of the pressure plate 214, and second motor 616 for controlling the rotation of the second screw and thus the pressure applied by the first actuator wedge.

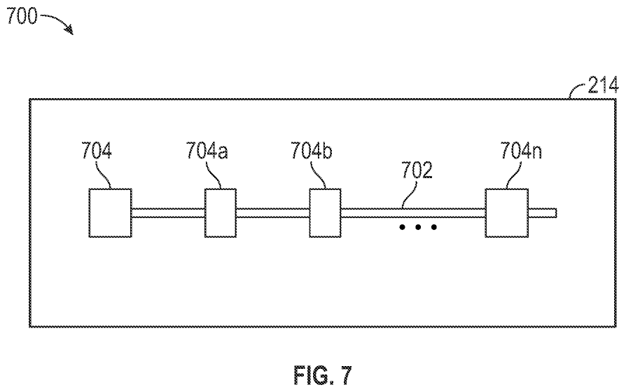

FIG. 7 shows the actuator device 700 in another embodiment. The actuator device 700 includes a screw 702 having more than two actuator wedges 704a, . . . 704n and the pressure plate 214 can have an equivalent number of plate wedges. A motor 706 can be used to rotate the screw 702 to cause the more than two actuator wedges 704a, . . . , 704n, to move to thereby apply pressure at multiple locations along the pressure plate 214.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An apparatus for controlling a pressure within a battery, comprising:
a support plate at a first side of the battery;
a pressure plate disposed at a second side of the battery opposite the first side, the pressure plate movable with respect to the support plate to control the pressure of the battery;
a first plate wedge coupled to the pressure plate; and
a first actuator wedge in contact with the first plate wedge, the first actuator wedge configured to move parallel to the pressure plate to control a force applied by the first actuator wedge to the first plate wedge to move the pressure plate with respect to the support plate, wherein moving the pressure plate controls the pressure within the battery.

2. The apparatus of claim 1, further comprising a second plate wedge coupled to the pressure plate and a second actuator wedge for controlling a force applied to the second plate wedge, wherein the second actuator wedge moves anti-parallel to the first actuator wedge.

3. The apparatus of claim 2, further comprising a screw that passes through the first actuator wedge and the second actuator wedge, wherein the screw has a first thread direction at the first actuator wedge and a second thread direction at the second actuator wedge.

4. The apparatus of claim 3, wherein the screw is maintained at a fixed location with respect to the support plate.

5. The apparatus of claim 4, further comprising a motor for rotating the screw.

6. The apparatus of claim 5, further comprising a pressure sensor configured to detect the pressure within the battery and a controller configured to control the motor based on the pressure to control the pressure within the battery.

7. The apparatus of claim 1, wherein the first plate wedge includes a first inclined surface and the first actuator wedge has an first actuator inclined surface in contact with the first inclined surface of the first plate wedge and is oriented in an opposite direction as the first inclined surface.

8. A method for controlling a pressure within a battery, comprising:
disposing the battery between a support plate at a first side of the battery and a pressure plate disposed at a second side of the battery opposite the first side, the pressure plate movable with respect to the support plate to control the pressure of the battery and including a first plate wedge;
moving a first actuator wedge parallel to the pressure plate, the first actuator wedge in contact with the first plate wedge, to control a force applied by the first actuator wedge to the first plate wedge to move the pressure plate with respect to the support plate; and
controlling the pressure within the battery by moving the pressure plate.

9. The method of claim 8, wherein the pressure plate includes a second plate wedge, further comprising moving a second actuator wedge for controlling a force applied by the second actuator wedge to the second plate wedge, wherein the second actuator wedge moves anti-parallel to the first actuator wedge.

10. The method of claim 9, wherein a screw passes through the first actuator wedge and the second actuator wedge, wherein the screw has a first thread direction at the first actuator wedge and a second thread direction at the second actuator wedge.

11. The method of claim 10, further comprising maintaining the screw at a fixed location with respect to the support plate.

12. The method of claim 11, further comprising rotating the screw via a motor.

13. The method of claim 12, further comprising detecting the pressure within the battery and controlling the motor based on the pressure to control the pressure within the battery.

14. The method of claim 8, wherein the first plate wedge includes a first inclined surface and the first actuator wedge has an first actuator inclined surface in contact with the first inclined surface of the first plate wedge and is oriented in an opposite direction as the first inclined surface.

15. A vehicle, comprising:
a battery;
a support plate at a first side of the battery;
a pressure plate disposed at a second side of the battery opposite the first side, the pressure plate movable with respect to the support plate to control a pressure of the battery;
a first plate wedge coupled to the pressure plate; and
a first actuator wedge in contact with the first plate wedge, the first actuator wedge configured to move parallel to the pressure plate to control a force applied by the first actuator wedge to the first plate wedge to move the pressure plate with respect to the support plate, wherein moving the pressure plate controls the pressure within the battery.

16. The vehicle of claim 15, further comprising a second plate wedge coupled to the pressure plate and a second actuator wedge for controlling a force applied to the second plate wedge, wherein the second actuator wedge moves anti-parallel to the first actuator wedge.

17. The vehicle of claim 16, further comprising a screw that passes through the first actuator wedge and the second actuator wedge, wherein the screw has a first thread direction at the first actuator wedge and a second thread direction at the second actuator wedge.

18. The vehicle of claim 17, wherein the screw is maintained at a fixed location with respect to the support plate.

19. The vehicle of claim 18, further comprising a motor for rotating the screw.

20. The vehicle of claim 15, further comprising a pressure sensor configured to detect the pressure within the battery and a controller configured to control a motor based on the pressure to control the pressure within the battery.
